(19) United States
(12) Patent Application Publication
(10) Pub. No.: US 2020/0074403 A1
(43) Pub. Date: Mar. 5, 2020

(54) Method For Distributing Orders

(71) Applicant: Ilya Vladimirovich Redkokashin, Rostov-on-Don (RU)

(72) Inventor: Ilya Vladimirovich Redkokashin, Rostov-on-Don (RU)

(21) Appl. No.: 16/347,575

(22) PCT Filed: Nov. 3, 2017
(86) PCT No.: PCT/RU2017/000818

§ 371 Date: May 4, 2019

(30) Foreign Application Priority Data
Nov. 6, 2016 (RU) 2016143436

(51) Int. Cl. G06Q 10/08; H04W 4/029; H04W 4/35

(52) U.S. Cl. CPC G06Q 10/08355; G06Q 10/0833; H04W 4/35; G06Q 10/0832; H04W 4/029; G06Q 10/0836

(57) ABSTRACT

The invention relates to the field of distributing orders, and more particularly to distributing orders between retail points and to automatic methods for distributing orders between retail points, taking into consideration their location. The present method includes: distributing orders automatically using a server on the basis of orders and information received from users and taking into consideration the information received, said orders being distributed between retail points chosen by the users, or between retail points which will have the orders ready by the time the users arrive or which will fulfil most of the preparation of said orders, for which purpose the location of retail points capable of fulfilling the orders and the time required to prepare the orders are taken into consideration. The proposed invention makes it possible to distribute orders between retail points, optimize the load on production facilities, and increase the load on production facilities.

### TECHNICAL FIELD

The invention relates to the field of distribution of orders, in particular to the distribution of orders among points of sales. More specifically, the invention relates to the automated methods of distribution of orders among points of sales taking into account their location.

### PRECEDING LEVEL OF TECHNOLOGY

Currently, the known method of serving clients is of McDonald's trading network, which assumes serving clients that receive their orders without leaving their car. For these purposes, point of issue and cashier are located by the road on which cars are moving. After cars drive up to a cashier and clients pay for the product directly from the window of their car, the order is being prepared and after a short period of time clients receive their order as well through the window of their car. This method is convenient and allows not to leave your vehicle while ordering, but has several disadvantages. First of all, a queue of cars, that are waiting for their order, is created, which leads to a loss of clients' time while they wait for their orders. Secondly, this method assumes ordering only at one point of sales, while, some other products of interest might be at another point of sales, at which the client will need to queue up, pay and wait for the order again. Also, if the client is at home and not planning to come to the point of sales, delivery is provided only when the client will make a relatively large purchase, since the delivery of a small order by traditional methods is not justified.

There are also known ways to distribute orders, that are used by the companies, like taxi “ [symbol] ep”, “Uber”, “Red taxi” etc. These companies take orders from clients on passenger transport by taxi via mobile applications and phone calls and subsequently allocate these orders among drivers, with which the aforementioned companies have contracts. As a rule, orders are received by the drivers, that are closest to the client, while the price of transportation is set by one of the above mentioned companies in accordance with the fixed rules. This method of order distribution is convenient for taxi orders, but this method has several disadvantages, in connection with which its use is unjustified, for example, when ordering food. First of all, this method does not take into account additional factors, influencing the order, for example, the availability of the ordered products at the point of sales, as in the taxi case any available driver is ready to accept the distributed order by default. But at points of sales, product of client's interest is not always available. Secondly, the method assumes that a taxi will be moving towards the client and not the other way round, therefore, it is absolutely reasonable with the above method to always transfer the order to the nearest taxi driver. But in case with the food order, the situation may be different, where the client wants to save time and not to wait for the order next to the point of sales, or where while driving the car and building the route around the city, the nearest point of sales will not suit the client, due to the fact, that the client will arrive earlier than his order will be ready, in addition, the nearest point of sales might be in the opposite direction and will not match customer's route. Thirdly, this method assumes distribution of order to one particular driver, while in case with products, different products might be available at different points of sales, so it will be necessary to split the order and allocate it among several vendors.

In this way, all of the above mentioned and other similar solutions do not solve the problems described.

The task, that the developer has regarding the new method of allocating orders, is to develop a way, which in comparison with the known analogues would ensure the distribution of orders.

The technical result of the proposed method of distribution of orders is to ensure the distribution of orders among points of sales, optimize the load of production equipment, increase the load of production equipment.

### DISCLOSURE OF INVENTION

The essence of the method of order distribution is that, at the beginning, the user is provided with the ability to create and send order requests using electronic computing devices and the Internet, then, after the order is created and sent by the user, the received order is transferred to one of the points of sales, based on the location of the user and points of sales of products, that have available requested by the user products, or provide the user with the ability to choose point of sales, moreover, the distribution of orders is made in such a way that the user does not spend his time waiting for the order, standing at the point of sale. The user can create and send requests through contacting operator, or using software application, moreover, it is possible to pay for the product and choose a point of sales using software application. The user can be informed about the availability of products being ordered at various points of sales, as well as about the time of preparation of the order in real time, as well as about the existing queue and possibility of preparing the order before user's arrival. In its turn, point of sales can be informed about the coordinates of the user who made the order, to predict the time of arrival of the user to the point of sales. With the help of mobile application it is possible to receive data from the user's navigator, and by predicting the route of the user, the order can be transferred to at least one point of sales in accordance with the user's route, and also transfer data to the point of sales about the movement of the user. Vending machine can be used as a point of sales, which after receiving the order, automatically prepares the order. To improve convenience, if necessary, once at the point of sales, the user can receive the order right after making request about order receiving in the mobile application. After user's request about receiving the order, if vending machine has been chosen as the point of sales, by means of vending machine located next to the road, the order will automatically be delivered to the user on a long stand, so that the user could get his order without leaving the car.

### EXAMPLE OF A SPECIFIC APPLICATION OF THE INVENTION

The proposed method of order distribution is as follows.

To implement the proposed method create a software application, for example for mobile phones. As soon as the user wants to eat, but will not have time wait until, for example, a hot dog with a glass of apple juice will be prepared. The aforementioned user with the help of the aforementioned application, reproducible on one of the personal or public devices, such as computer, cellular phone etc., and also the Internet, creates and sends order requests, choosing in the catalog those products, that he is interested in at that moment, based on the example this is a hot dog and apple juice. Then the user makes a payment in convenient for him way, for example using the mobile bank. The user can choose which points of sales will execute the order and set the time of the arrival to the point of sales, if his planning, for example, to pass by the point of sales, or choose home delivery, and also points of sales can be automatically chosen by the app. If points of sales will be chosen automatically, then for distribution of the order it will be analyzed whether the user will be travelling, for example in the next 30 minutes, or will stay at home. If the user is planning to travel by car, then the mobile phone will receive information from the navigator, which can be a separate device or the phone's built-in application, and will transfer the information to the server. Based on the user's route, speed of the car movement, availability of products and load on points of sales, server will automatically allocate the orders among points of sales and will inform the user about points of sales, which will execute the order, and also about the time required to prepare the order. For example, a hot dog can be ordered at one point of sales next to the road, but apple juice in another one. Moreover, orders can be distributed to vending machines, located next to the road, which automatically prepare the order. When the user is approaching the point of sales, a button in the application can be pressed, so that his order is immediately issued to him. In case of vending machine, the order can moveout towards the roadway on a special stand, so that the user could get the order without leaving the car. It is possible to create a mechanism, such that will issue the order to the user even if the user will not stop while passing by on a car. For example, using a stick with a magnet on its end and a thin metal plate applied to the package of the order.

A user can request an order by calling a telephone operator. In this case operator can specify the details of the order and can decide himself to which point of sales to allocate each product from the order.

If the user, for example, is not planning to travel and stays at home, there will not be free delivery of cheap goods, especially over long distances. In this case orders will be distributed to the nearest points of sales, where the requested products are available, and the order will be delivered using unmanned aerial vehicles. The distribution of orders to the nearest points of sales and delivery with unmanned aerial vehicles allow to deliver even the cheapest goods for free and in shortest periods of time.

The described invention provides optimization of the load of production equipment due to distribution of orders among different points of sales. Server knows the load of production equipment at different points of sales, as it allocates orders, and allocates them based on such factors as queue, moreover, due to the described above method, server knows about the necessity of preparing the orders in advance, when users are still on their way, that allows to allocate orders among points of sales more effectively, and hence more effectively optimize the load on production equipment. It is always better to plan ahead and allocate the orders in advance, then to receive orders directly at the till, where orders are distributed depending on random circumstances.

Increased production equipment load is achieved through additional orders that would not arise due to the rush of users who have no time to wait for the preparation of their order. Moreover, additional orders, that are described as load boosters, are also distributed among equipment, and that optimizes equipment utilization. For example, what should be understood by optimization of production equipment load is that when there is, for example, 10 units of equipment and, for example, there is need to produce more than 50 units of product within an hour, due to optimization each unit of equipment will be producing 5 units of product, instead of having chaotic process of distribution, where some units of equipment would produce more than 10 units of product, and other less than 3, for example. In this case, for example, by increasing the load of these 10 units of equipment, having need, for example, to produce 60 units of product instead of 50, the load would be optimized and each unit of equipment would produce 6 units of product. Thus, increasing the load on production equipment and optimizing the load on production equipment take place simultaneously.

### INDUSTRIAL APPLICABILITY

Proposed method of order distribution is used for orders distribution, optimization of the load of production equipment, increasing the load of production equipment.

1. A method of orders distribution, in which based on the order and information received from users, orders are automatically distributed among points of sales based on:
information obtained by the server to points of sales chosen by the user; or
to points of sales that will be able to prepare the order by the time the user arrives; or
to points of sales that will be able to make most of the preparations for the above orders;
based on the location of points of sales that are able to execute the order and time needed to prepare the orders;
wherein distributed orders are received by points of sales via an electronic computer, while the information, received from the user, represents information about chosen points of sales and time of arrival, or information predicting movements of the user, obtained using mobile phones of the user, that receive information from navigators, which can be separate devices or built-in phone applications, or information, received from the user, about their further movements, and what is more, predicted or received information about user movements includes:
user's location,
user trajectory,
user's movement speed.

2. The method of orders distribution based on claim 1, wherein the method comprises instructions stored on a non-transitory computer readable medium that when executed by a processor cause the processor to carry out the method of orders distribution recited in claim.

3. The method of orders distribution based on claim 2, wherein the user, while creating order, is informed about possibility of executing the order in different points of sales.

4. The method of orders distribution based on claim 3, wherein real time information: about the time needed to prepare the order, about existing queue and about possibility of preparing the order before the user arrives, is sent to the user.

5. The method of orders distribution based on claim 4, wherein with the help of mobile application, coordinates of users, that have made the order, will be transferred to points of sales, that received orders, in real time, in order to predict users' arrival time to points of sales.

6. The method of orders distribution based on claims 1, wherein vending machines, that automatically prepare orders after receiving them, can be used as points of sales.

7. The method of orders distribution based on claim 6, wherein users, after arriving to the point of sales, are able to receive their order immediately after making such request in the mobile application.

8. The method of orders distribution based on claim 7, wherein after making a request on receiving the order from the vending machine, located next to the road, user's order automatically moves out towards the roadway on a long stand, so that the user could get his order without leaving the car.

9. The method of orders distribution based on claim 1, wherein, after receiving users' information about their further movements and after transferring orders to points of sales, orders will be delivered to users using unmanned aerial vehicles.

10. The method of orders distribution based on claims 9, wherein the user, while creating an order, is informed about possibility of getting the order at different points of sales.

11. The method of orders distribution based on claim 10, wherein the user will be informed about the time needed to prepare the order in real time and about an existing queue.

12. The method of orders distribution based on claim 9, wherein vending machines are used as points of sales, which after receiving an order, automatically prepare it and deliver it with unmanned aerial vehicles.
